(19) United States
(12) Patent Application Publication
(10) Pub. No.: US 2011/0093896 A1
(43) Pub. Date: Apr. 21, 2011

(54) SYSTEM AND METHOD FOR PROVIDING TELEVISION PROGRAM REMINDERS

(75) Inventor: Minqing Xing, Fishers, IN (US)

(73) Assignee: SHENZHEN TCL NEW TECHNOLOGY LTD., Shekou, Shenzhen, Guangdong (CN)

(21) Appl. No.: 12/993,692

(22) PCT Filed: Oct. 23, 2008
(86) PCT No.: PCT/US08/80921

§ 371 Date: Nov. 19, 2010

(30) Foreign Application Priority Data
Jun. 13, 2008 (CN) CN200810067697.9

(51) Int. Cl. H04N 5/445

(52) U.S. Cl. 725/40; 725/37

(57) ABSTRACT

There is provided a system and method for providing television program reminders. More specifically, in one embodiment, there is provided a method comprising receiving television program selection data, comparing the television program selection data with descriptive data for a plurality of television programs, and presenting an alert message when the descriptive data for at least one of the plurality of television programs matches at least a portion of the television program selection data.

### FIELD OF THE INVENTION

The present invention relates generally to systems and methods that facilitate efficient observation of television programs. More particularly, the present invention relates to a system and method for alerting a user to available television programs of interest to the user.

### BACKGROUND OF THE INVENTION

This section is intended to introduce the reader to various aspects of art, which may be related to various aspects of embodiments of the present invention that are described and/or claimed below. This discussion is believed to be helpful in providing the reader with background information to facilitate a better understanding of the various aspects of embodiments of the present invention. Accordingly, it should be understood that these statements are to be read in this light, and not as admissions of prior art.

Watching television is a very popular pastime. Television viewers often have access to a large number of channels that provide a variety of programs. This can actually make it difficult for a viewer to select a program to watch. For example, a user may be required to browse all of the available channels (e.g., analog channels and/or digital channels) to find a program that the user wants to view. Some traditional televisions may provide access to a program guide that provides a list of available programs and the corresponding channels that are presenting each program. This may allow a user to select a program for viewing without browsing through the channels. However, even with the assistance of a programming guide, users often miss their favorite programs because they are watching something else or because they forget when a program starts or on which channel the program is being presented.

### BRIEF DESCRIPTION OF THE DRAWINGS

Advantages of the invention may become apparent upon reading the following detailed description and upon reference to the drawings in which:

FIG. 1 is a block diagram of a television system in accordance with an exemplary embodiment of the present invention;

FIG. 2 is a block diagram of a method in accordance with an exemplary embodiment of the present invention; and

FIG. 3 is a block diagram of a software program stored on a computer-readable medium in accordance with present embodiments.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Most television viewers likely have a few favorite topics that they are interested in watching television programs about. Similarly, most television viewers likely have certain recurring television programs they enjoy watching. Browsing through available channels to find such television programs can be inefficient and time consuming. Further, even when users employ a program guide, they often miss their favorite programs (e.g., a particular television series) or programs of interest (e.g., a one-time presentation) because they are watching something else or forget the programs are being aired. Additionally, the use of the program guide may be inconvenient and confusing. Accordingly, embodiments of the present invention relate to sending a reminder to the user based on a comparison of user settings (e.g., the user's favorite program titles or subject matter) with program data (e.g., extended data services (XDS) or program and system information protocol (PSIP) data that is transmitted in the broadcast data stream) to alert the user of current or future programs that the user may be interested in viewing.

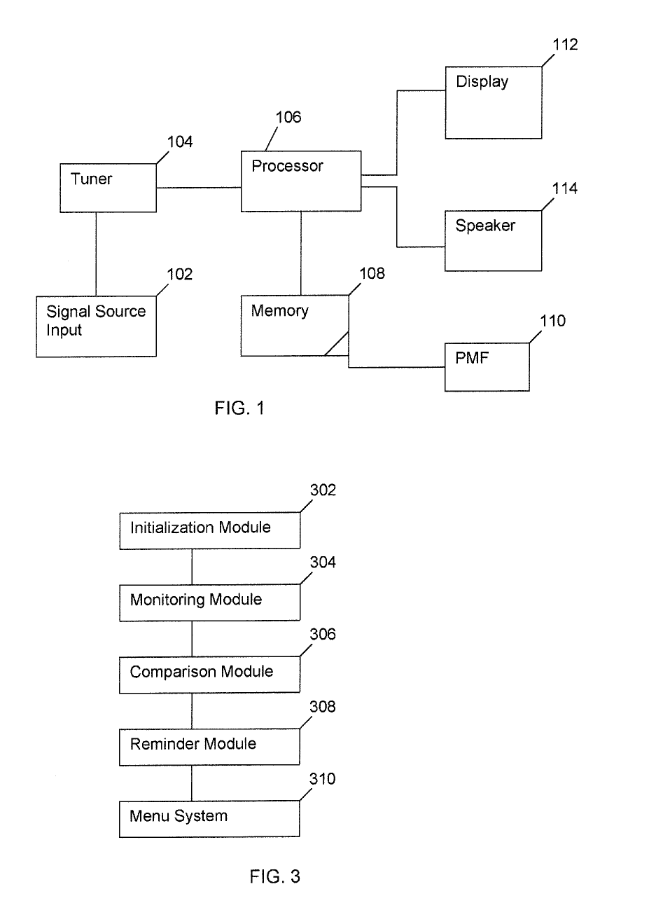

FIG. 1 is a block diagram of an electronic device that may employ a parental control system in accordance with an exemplary embodiment of the present invention. The electronic device is generally indicated by reference numeral 100. The electronic device 100, which may include a television, DVD player, set-top box or the like, comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements. Specifically, in the illustrated embodiment, the electronic device 100 includes a signal source input 102, a tuner 104, a processor 106, a memory 108, a program monitoring feature (PMF) 110, a display 112 and a speaker 114.

The signal source input 102 may comprise an antenna input, a cable input, an RCA input, an s-video input, a composite video input or the like. Those of ordinary skill in the art will appreciate that the signal source input 102 may be representative of multiple signal source inputs. For example, the electronic device 100 may include a first signal source input that receives a broadcast signal and a second signal source input that receives a stored video signal, such as an input from a DVD player. In an exemplary embodiment of the present invention, the signal received by the signal source input 102 comprises video data and/or audio data.

In the illustrated embodiment, the tuner 104 is communicatively coupled with the signal source input 102. The tuner 104 is adapted to tune a particular video program from a broadcast signal received from the signal source input 102. In some embodiments the tuner 104 may be bypassed if the signal source input 102 receives a stored video signal. Indeed, those of ordinary skill in the art will appreciate that input signals that are not received as part of a broadcast spectrum may bypass the tuner 104 because tuning is not required to isolate a video program associated with those signals.

The processor 106 is adapted to control the overall operation of the electronic device 100. Such control may be achieved by the processor 106 when the processor 106 cooperates with the memory 108 to perform operations in accordance with embodiments of the present invention. Specifically, for example, the memory 108 may be associated with the processor 106 such that the memory 108 stores machine-readable computer code that causes the processor 106 to control the operation of the electronic device 100 in a manner in accordance with present embodiments.

The PMF 110 may include hardware, software or a combination thereof. For example, in one embodiment, the PMF 110 may include a software program stored in memory (e.g., the memory 108). The PMF 110 is adapted to receive information regarding one or more particular television programs. For example, a user may input program selection data (e.g., a title, keyword or description of a specific television program) into the device 100 using the PMF 110. The program selection data may define a favorites list for a particular user or for any use of the electronic device 100. In some embodiments, the PMF 110 may obtain the program selection data based on a historical log of television programs that have been presented via the electronic device 100. For example, if certain programs are viewed more frequently than others, program selection data for those programs may be added to a favorites list. Once obtained, the program selection data is used by the PMF 110 to select television programs to be the subject of reminders, as will be discussed in further detail below.

The display 112 of the electronic device 100 is configured to display video data initially received via the signal source input 102. The display 112 may comprise a liquid crystal (LCD) display, a liquid-crystal-on-silicon (LCOS) display, a digital light projection (DLP) display or any other suitable display type. The display 112 may include a lighting source (not shown) that is used to facilitate presentation of a visible image (e.g., video data from a television program or a user interface) on the display. The display 112 may cooperate with the speaker 114 to present audio and visual data for a television program.

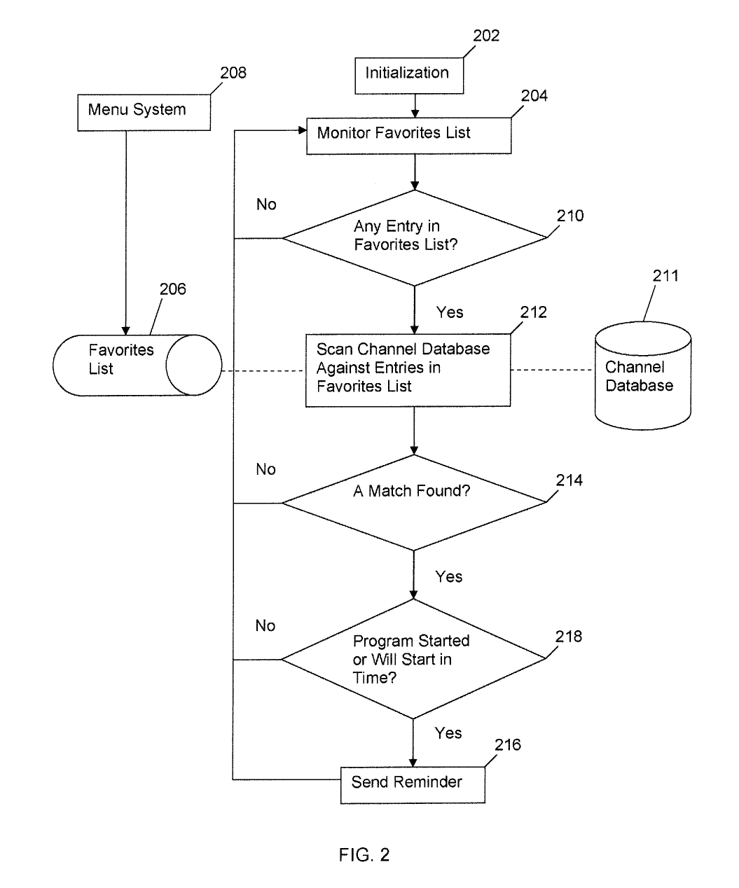

FIG. 2 is a process flow diagram in accordance with an exemplary embodiment of the present invention. The process is generally indicated by reference numeral 200. The process 200 includes various components or steps that allow a user to input or preset certain user settings or program selection data (e.g., television program titles or keywords). Once the program selection data is identified, the process 200 alerts the user when programs with features matching certain components of the program selection data are available or will be available for viewing. Specific features of the process 200 will be discussed in further detail below. It should be noted that while FIG. 2 illustrates one embodiment of the present invention, in other embodiments, as would be appreciated by one of ordinary skill in the art, some components or steps of the process 200 may be modified, excluded, or additional steps may be included.

The process 200 begins with an initialization, as represented by block 202. The initialization of block 202 may include powering up the electronic device 100 or turning on a program monitoring feature of the electronic device 100. In other words, embodiments of the present invention may automatically initialize at startup of an associate device (e.g., television) or upon activation by a user. In some embodiments, block 202 may represent a user logging into a system in accordance with present embodiments. Indeed, logins may be used to distinguish between users. For example, various users may have different interests, and allowing users to log in may enable the process 200 to distinguish between which programs are of interest to the various users. Specifically, for example, a first user may have certain user settings associated with a first login that will be used to compare with available programs and a second user may have different user settings associated with a second login.

After initialization at block 202, the process 200 continues to block 204, which represents monitoring a favorites list 206. The favorites list 206 may include the program selection data (e.g., key words, program titles, and the like) for one or more users. The favorites list 206 may be defined by a user via a menu system 208. For example, the menu system 208 may include a navigable menu that is presented to the user via the electronic device 100. The menu system 208 allows a user to input the names and/or keywords associated with his or her favorite shows, thus defining the program selection data of the favorites list 206. In some embodiments, the favorites list 206 may be automatically constructed based on programs that are viewed over a period of time. For example, program titles or descriptions found in PSIP or XDS data for frequently viewed programs may be utilized to define the favorites list 206. Further, in some embodiments, the favorites list 206 may include default settings for the program selection data.

Based on the monitoring of the favorites list 206, as represented by block 204, a determination is made as to whether the favorites list 206 includes any entries. That is, a determination is made as to whether the favorites list 206 includes any program selection data. Such a determination is represented by block 210. If no entries are present, the process continues to monitor (block 204). However, if entries are present, data from available programs 211 (e.g., PSIP and XDS data from current and future programs) is compared with the entries in the favorites list 206. For example, block 212 represents comparing a channel database with the user settings of the favorites list 206. The channel data base may be created with a background process within control software in accordance with present embodiments. The control software may scan the current and future program names and program descriptions retrieved from XDS or PSIP data for the respective programs 211. This channel database may be compared with the favorites list 206 to determine if a match exists, as represented by block 214. For example, if a keyword or title set forth in the user settings matches a title of a program or a word in a description of the program, such as in the PSIP data or XDS data, a match exists with that particular program.

If a match does not exist, the process 200 continues to monitor (block 204). If a match does exist, as determined in block 214, this indicates that a currently available program or a program that has been assigned a presentation time in the future would likely be of interest to the user and, thus, the user may be notified. Specifically, in some embodiments, if a match is found and the program is currently showing or the program will be showing within a certain time, a reminder (e.g. an alert panel) will be presented to the user, as represented by block 216. The reminder may include information such as the channel number, program name, program start time and so forth for the matching program. The alert may be presented on the electronic device 100 in accordance with some embodiments. However, the process can also be configured to send reminders via emails or text messages to separate devices (e.g., a computer or cell phone). This may be desirable when the electronic device is off. Indeed, in some embodiments, the process 200 includes determining whether the electronic device 100 is off and sending the alert to an alternative destination if it is off.

In the illustrated embodiment, rather than immediately notify the user when a match is found in block 214, a determination is made as to whether the program has already started or will start within a defined time period (e.g., a designated window of 30 minutes). Such a determination is represented by block 218. This may reduce or prevent the issuance of notifications (e.g., alerts) about programs that are too far in the future to be of concern to the user. In some embodiments only programs with start times within a certain time window are monitored to reduce such notifications. Further, in some embodiments, the user may designate the time window. For example, the user may input a time value in the menu system 208 that will be used to limit which programs are monitored based on their estimated start time or run times. Indeed, rather than finding a match and then determining whether the program is within a time window, only programs within the time window may be monitored to reduce undesired alerts.

Once an alert is sent, the process 200 may include marking the alert as “sent” to avoid redundant alerts. Upon receiving an alert, the user can decide whether to switch to the channel presenting the program designated by the alert or not. In some embodiments, the user may actually select a feature of the alert to tune to the program rather than separately tune to the channel. For example, the alert may include a navigable menu that allows the user to select and immediately tune to a channel displaying a program of interest. Further, the alert may include notifications regarding multiple programs and a user may navigate the alert to select a one of the programs for viewing.

FIG. 3 is a block diagram of a software program stored on a computer-readable medium (e.g., memory 108) in accordance with present embodiments. Specifically, FIG. 3 includes an initialization module 302, a monitoring module 304, a comparison module 306, a reminder module 308, and a menu system 310 that cooperate to perform a process in accordance with present embodiments. The initialization module 302 is configured to initialize the program. For example initialization may occur upon turning on the electronic device 100. The monitoring module 304 is configured to monitor the program selection data. The comparison module 306 is configured to compare the program selection data to data from available programs (e.g., programs that are in progress or will start within a designated time window). The reminder module 308 is configured to initiate an alert when certain matches are found between the program selection data and available programs. The menu system 310 may be configured to enable a user to input the program selection data. In some embodiments, the monitoring module 304 automatically obtains the program selection data by recording data relating to observed programs over a time period.

One advantage of embodiments of the present invention is that it automatically monitors and scans television program names and program descriptions retrieved from XDS or PSIP data embedded in the program data stream and reminds the user via alert panels on the electronic device (e.g., a television), emails or text messages on a cell phone or computer. It is believed that this will greatly reduce the chance of missing television shows of interest to the user.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims

What is claimed is:

1. A method, comprising:
receiving television program selection data;
comparing the television program selection data with descriptive data for a plurality of television programs; and
presenting an alert message when the descriptive data for at least one of the plurality of television programs matches at least a portion of the television program selection data.

2. The method of claim 1, wherein comparing the television program selection data with the descriptive data comprises comparing the television program selection data with television programs that are currently being broadcast or will be broadcast within a defined amount of time.

3. The method of claim 1, comprising retrieving the descriptive data from a program guide.

4. The method of claim 1, comprising retrieving the descriptive data from a broadcast signal for each of the plurality of television programs.

5. The method of claim 1, wherein comparing the television program selection data with the descriptive data for the plurality of television programs comprises comparing the television program selection data with keywords, program titles or content descriptions for the plurality of television programs.

6. The method of claim 1, comprising retrieving the descriptive data from XDS data, PSIP data or both XDS and PSIP data associated with the plurality of television programs.

7. The method of claim 1, wherein presenting the alert message comprises presenting the alert message within a designated time prior to a start time of the at least one of the plurality of television programs.

8. The method of claim 1, wherein presenting the alert message comprises displaying an alert panel on a display of a media device.

9. The method of claim 8, wherein the alert panel comprises indicators for a channel, a program name and a program start time for the at least one of the plurality of television programs.

10. The method of claim 1, wherein presenting the alert message comprises presenting an activation option, wherein selection of the activation option initiates tuning of a channel that is presenting the at least one of the plurality of television programs.

11. The method of claim 1, wherein presenting the alert message comprises presenting a list of activation options, wherein selection of a one of the activation options initiates tuning of a channel that is presenting the at least one of the plurality of television programs.

12. The method of claim 1, wherein presenting the alert message comprises transmitting the alert message as an email or as a text message.

13. A computer program stored on a computer-readable medium, comprising:
a user setting module configured to receive television program selection data;
a comparison module configured to compare the television program selection data with descriptive data for a plurality of television programs; and
an alarm module configured to present an alert message when the descriptive data for at least one of the plurality of television programs matches at least a portion of the television program selection data.

14. The computer program of claim 13, wherein the comparison modules is configured to compare the television program selection data with television programs that are currently being broadcast or will be broadcast within a defined amount of time.

15. The computer program of claim 13, wherein the user setting module is configured to retrieve the descriptive data from a program guide.

16. The computer program of claim 13, wherein the user setting module is configured to retrieve the descriptive data from a broadcast signal for each of the plurality of television programs.

17. The computer program of claim 13, wherein the comparison module is configured to compare the television program selection data with keywords, program titles or content descriptions for the plurality of television programs.

18. The method of claim 13, wherein the user setting module is configured to retrieve the descriptive data from XDS data, PSIP data or both XDS and PSIP data associated with the plurality of television programs.

19. The method of claim 13, wherein the alarm module is configured to present the alert message within a designated time prior to a start time of the at least one of the plurality of television programs.

20. A system, comprising:
means for receiving television program selection data;
means for comparing the television program selection data with descriptive data for a plurality of television programs; and
means for presenting an alert message when the descriptive data for at least one of the plurality of television programs matches at least a portion of the television program selection data.
